(19) United States
(12) Patent Application Publication
(10) Pub. No.: US 2016/0021042 A1
(43) Pub. Date: Jan. 21, 2016

(54) VIDEO MESSAGING

(71) Applicant: Flips, LLC, Colleyville, TX (US)

(72) Inventors: Anthony Alfieri, Euless, TX (US); Taylor Vincent Hartnett, Colleyville, TX (US); Robert Edward Washington, JR., Euless, TX (US)

(21) Appl. No.: 14/802,318

(22) Filed: Jul. 17, 2015

Related U.S. Application Data
(60) Provisional application No. 62/026,505, filed on Jul. 18, 2014.
(60) Provisional application No. 62/163,817, filed on May 19, 2015.

(51) Int. Cl. H04L 12/58

(52) U.S. Cl. CPC H04L 51/10

(57) ABSTRACT

Texts message(s) may be provided via an app on a user device. A video message may be generated based at least partially on phrases in the text message and media including video, audio, and images associated with the phrases. The generated video message may be transmitted to other users.

### CROSS REFERENCE TO RELATED APPLICATION

The present application incorporates by reference U.S. Patent Application No. 62/026,505 filed Jul. 18, 2014, entitled “VIDEO MESSAGING,” and U.S. Patent Application No. 62/163,817 filed May 19, 2015, entitled “VIDEO MESSAGING,” both of which are incorporated herein by reference in their entirety.

### TECHNICAL FIELD

The present invention relates to video messaging.

### BACKGROUND

Currently for a user to send a friend a video message, the user records a video by, for example, using a camera on the user's phone, and sends the friend a multimedia messaging service (MMS) message and/or email with a video clip attached. This is slow since it requires the user to record a video each time the user would like to send a video message. Alternatively, the user may send a short message service (SMS) message including text that the user would like to send to a friend. However, the text message may not convey the desired tone and may be less interesting to the friend than a video.

### SUMMARY

Embodiments of the present disclosure generally provide a method of generating a video message including providing a text message to a receiver. A first user may provide the text message on at least one first user device and media may be retrieved from the at least one first user device based on the text message. Further, the method may provide for generating the video message based on receiver information that may be associated with the text message and the media retrieved from the at least one first user device. Additionally, the video message may be transmitted to at least one second user device or additional user devices.

Embodiments of the present disclosure may generally provide a system including non-transitory, computer readable medium. The system may include a receiving unit that may receive a text message, and at least one first user device that may provide the text message and retrieve media based on the text message. Further, the system may provide a text-to-video (TTV) module that may generate the video message based on receiver information associated with the text message and media retrieved from the at least one first user device. The at least one first user device may transmit the video message to at least one second user device.

In various implementations, a user may provide a text message that includes characters, such as alphanumeric characters and/or symbols, via a text to video application software (“TTV app”) on a user device. The TTV app may be communicably coupled to a TTV server (e.g., via a network). The TTV server and/or the user device may include one or more memories that include libraries (e.g., public and/or private, such as user, libraries) of video clips. Access to the libraries may be restricted and/or may not be restricted.

A text message may be provided via the TTV app on a user device. The text message may be analyzed (e.g., by a TTV module including the TTV app and/or the TTV server) and phrases in the text message may be identified. Video clip(s) associated with the phrases may be retrieved from libraries and/or provided by the user (e.g., from the user device and/or by recording a video clip). The TTV server may generate a video message including one or more of the retrieved video clips. The generated video message may be transmitted (e.g., via a network, such as cell phone networks; Wi-Fi; and/or accessories including, but not limited to, watches and bracelets) to other user(s). Other user(s) may receive and/or be presented the generated video message via TTV app(s) on the other user(s) device(s).

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 illustrates an implementation of an example system;

FIG. 2 illustrates an implementation of an example process to allow text to video messaging;

FIG. 3 illustrates an implementation of an example process to allow text to video messaging;

FIG. 4 illustrates an implementation of an example process to receive video messaging on a user device;

FIG. 5 illustrates an implementation of an example process to allow text to video messaging;

FIG. 6 illustrates an implementation of an example process to assign a word to existing media and/or new media in a video message;

FIG. 7 illustrates an implementation of an example process to assign existing media and/or new media in a video message;

FIG. 8 illustrates an exemplary video messaging method and system, as described herein;

FIG. 9 illustrates an exemplary video message; and

FIG. 10 illustrates an exemplary video message.

Like reference symbols in the various drawings indicate like elements.

### DETAILED DESCRIPTION

In various implementations, a user may provide text message(s) and a video message may be generated and transmitted based on the receiver information associated with the provided text message. For example, a first user may provide a first text message to be transmitted to a second user. The text message may be analyzed (e.g., parsed) and phrases associated with prerecorded videos clips may be identified and/or retrieved (e.g., from a library). The associated video clips may be utilized (e.g., combined) to generate a video message based on the provided text message. The video message may be transmitted to the second user (e.g., based on receiver information) rather than and/or in addition to the provided text message.

In various implementations, the user may provide a text message via a text to video application software (“TTV app”) stored on a user device. The text message may include characters such as, but not limited to: letters; numbers; or symbols, such as emoticons and/or punctuation; and/or any other appropriate characters. Phrases (e.g., one or more characters in the text message, such as word(s), number(s), etc.) in the text message may be identified (e.g., by the TTV app and/or the TTV server). The TTV app may be communicably coupled to a text to video server (“TTV server”). Media including, but not limited to, video clip(s), audio, images and combinations thereof associated with the phrases may be retrieved by the TTV app and/or TTV server and a video message may be generated based at least partially on the provided text message and the retrieved videos by the TTV server. The generated video message may then be transmitted to other user(s).

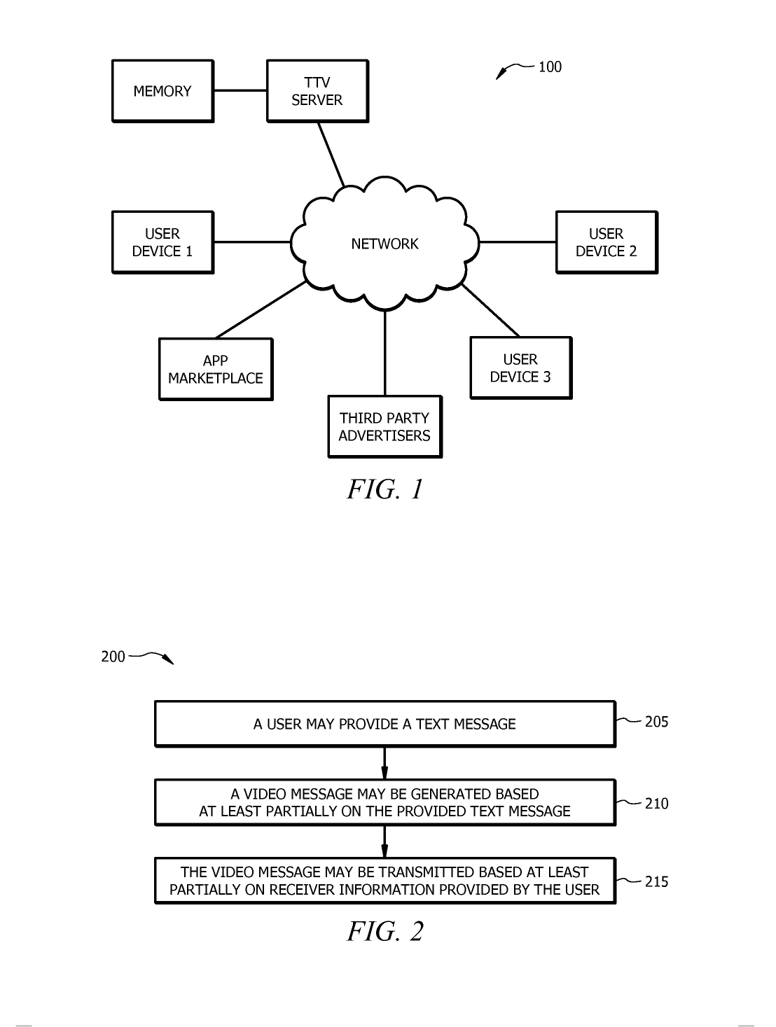

FIG. 1 illustrates an implementation of system 100. System 100 includes a plurality of user devices (such as user devices 1, 2, 3 in FIG. 1) coupled via a receiver or receiving unit, such as a network. The user devices may communicate with each other, the TTV server, the app marketplace(s) (e.g., to facilitate distribution of applications), and/or third party advertisers via the network. The network may include cell phone networks (e.g., GSM, CDMA, etc.); Wi-Fi; satellite networks; and/or accessories including, but not limited to, watches and bracelets. It should be appreciated that the video message may be displayed through a network even if the network is non-interactive.

The user device(s) may include any appropriate device. For example, a user device may include a smart phone, a tablet, and/or a smart watch. An additional user device(s) may include similar or different types of user devices. The user device may include a memory in which the TTV app may be at least partially stored. In some implementations, the user device may include remote storage (e.g., cloud storage) and at least a portion of the TTV app may be stored in the remote storage. The user device may include a processor to execute instructions in the TTV app to perform one or more of the operations to allow text messages to be provided as video messages to other users. In some implementations, a first user may access a TTV app on a phone and a second user may access the TTV app on a tablet computer.

The TTV app may be communicably coupled to the TTV server. The TTV app and the TTV server may perform operations together and/or independently that allow text messages to be provided as video messages to other users. The TTV server may include a memory. For example, a local or remote database may be coupled to the TTV server. The memory may store libraries of video clips. Access to the libraries may be restricted (e.g., based on user information such that access to a remote user library may be allowed or access to local libraries on a user device may be allowed) and/or unrestricted. For example, the libraries may be user specific (e.g., user library) and/or public (e.g., access to the library may not be restricted based on user information).

The TTV server may include instructions, such as modules or receiver information associated with text messages stored in the memory of the TTV server that are executed by a processor of the TTV server to perform operations to allow text messages to be transmitted to other users as video messages. For example, operations may include, but are not limited to: managing subscriber services (e.g., allowing access to the TTV app and/or TTV server, allowing access to add-on features of the TTV app, and/or other operations); determining whether to allow access to a library; managing access to one or more libraries, receiving text messages, analyzing text messages to parse and/or identify phrases in the text message; identifying which phrase(s) in a text message are associated with video clip(s) (e.g., in a user library and/or in a public library) and which phrase(s) are not associated with video clip(s); retrieving video clips based on the phrases in the text message; generating video messages based on one or more of the retrieved video clips; generating video messages based on user preferences; allowing editing of the generated video by a user; transmitting the generated video message based on receiver information; manage advertising videos; determining whether to associate an advertising video based on advertising criteria, user preferences, geolocation information, etc.; and/or other appropriate operations.

The system may also include other devices, such as third party advertiser(s) depicted in FIG. 1. A third party advertiser may transmit advertising video clips to the TTV server for storage on a memory of the TTV server. The TTV server may retrieve and/or transmit the stored advertising video clips from the third party advertiser based at least partially on the text message, geolocation information, and/or advertising criteria. In some implementations, a third party advertiser, such as a business and/or park, may be a subscriber of the TTV system and may have an associated public posting interface. The TTV server may maintain the public posting interface for the third party advertiser and/or allow users to transmit video messages to the public posting interface. The posted video messages may be viewed by users who access the public posting interface via the TTV app and/or the Internet.

Although FIG. 1 illustrates an implementation of a system that may allow conversion of text messages into video messages for transmission, other implementations may be utilized. For example, the server may include other types of memory on which videos are stored rather than a database. The database may be remote to the video server. The video server may be a web server. The user device may include one or more libraries in which video clips are stored. The TTV app may perform one or more of the operations of the TTV server instead of the TTV server and/or in conjunction with the TTV server.

In various implementations, a first user may utilize a TTV app on a first user device, which may be communicably coupled with the TTV server to generate video messages based on text messages provided by the first user. The first user may access the TTV app on more than one user device based on user information provided by the first user, in some implementations.

A first user may download the TTV app on a first user device. The TTV app may be downloaded from an app marketplace, in some implementations. The TTV app may be updated and/or modified via updates pushed out and/or downloaded from an app marketplace.

The TTV app may generate one or more graphical user interfaces to facilitate receipt of text messages and generation of video messages based on the provided text messages. For example, the TTV app may generate login interfaces, interfaces to accept provided text messages, interfaces to preview generated video messages, interfaces to facilitate capture of video clips, etc.

The TTV app may include a predefined listing of phrases (e.g., word(s), symbols, etc.) and/or may allow a user to create custom phrases that may be associated with video clips. For example, the TTV app may prompt a user to provide video clips of commonly used phrases and/or the user may provide video clips of custom phrases. The user may record video clips and/or otherwise select (e.g., retrieve from a photo library in a user device and/or in remote storage) video clips to be associated with the phrases. The video clips may be edited by a user via the TTV app (e.g., the recording length may be preselected and a user may alter the recording length, the video images may be altered, etc.). The video clips provided may be stored in a library (e.g., in a memory of the user device and/or the TTV server). Thus, a library of video clips associated with specific phrases may be generated and/or stored. The library may then be accessible by the TTV app and/or the TTV server to generate video messages.

FIG. 2 illustrates an implementation of example process 200 to allow generation of a personalized video message(s) based at least partially on a provided text message. A user may provide a text message (operation 205). The text message may include characters such as letters, symbols, emoticons and/or numbers. The text message may be provided by a user. For example, the text message may be typed by a user via the TTV app. The text message may be provided by a user when a user selects a message, such as a quick message. The text message may be provided by a user when a user speaks to the TTV app which receives the message (e.g., using voice recognition technology).

A video message may be generated based at least partially on the provided text message (operation 210). The text message may be analyzed (e.g., by the TTV app and/or the TTV server) to parse the text message and/or to identify phrases in the text message. Video clips may be retrieved that are associated with the phrases in the text messages (e.g., from a library). The video message may be generated from video clips. For example, the video clips may be joined together to form a video message. The video message may feature a person saying the phrases in the text message, in some implementations. Thus, the user receiving the video message may watch and/or hear the contents of the text message rather than read the text message.

The video message may be transmitted based at least partially on receiver information provided by the user (operation 215). The receiver information may include cell phone number(s), user name(s), group name(s), email address(es), social media site to which the user would like to upload the video message, etc. to which the text message will be transmitted.

Process 200 may be implemented by various systems, such as system 100. In addition, various operations may be added, deleted, and/or modified. In addition, the TTV app and/or the TTV server may perform one or more of the operations independently and/or in conjunction with each other.

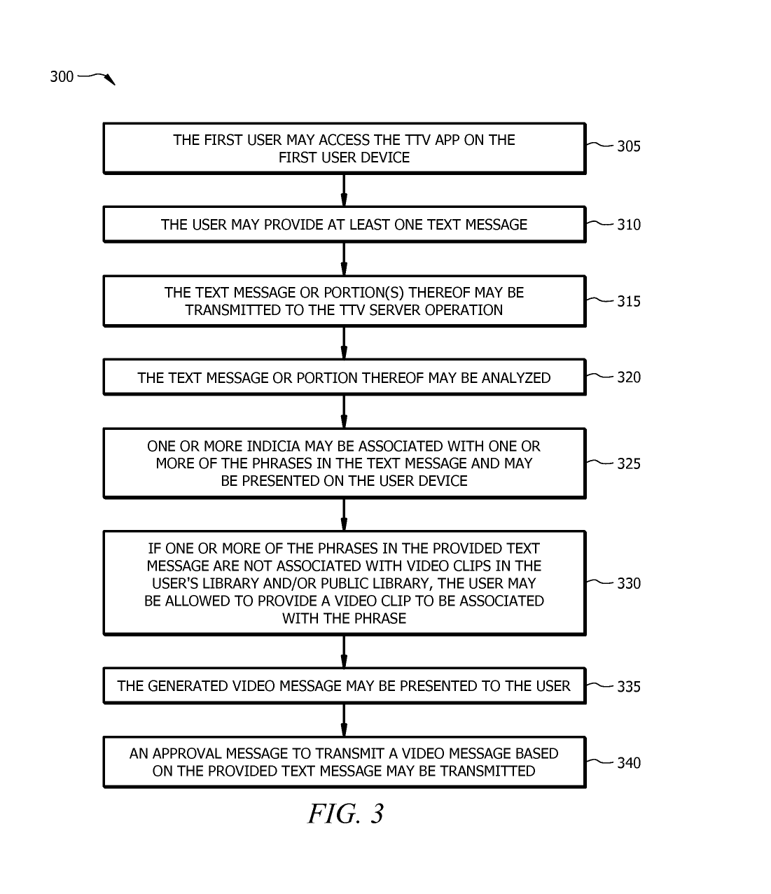

FIG. 3 illustrates an implementation of example process 300 to allow video messages to be generated from text messages. The first user may access the TTV app on the first user device (operation 305). For example, the first user may click or otherwise select TTV app on an interface presented on the first user device. The first user may provide user information, such as, but not limited to a password, username, UUID, etc.

In some implementations, the TTV app may automatically transmit the user information and/or remain “logged in” to the TTV server (e.g., for a period of time, until a user logs out of the app, etc.).

The user may provide at least one text message (operation 310). For example, a user may type a text message in a field of an interface generated by the TTV app. The user may provide the text message by, for example, gesturing, speaking, typing and/or otherwise inputting the message via the TTV app. The text message may include characters that form phrases, such as one or more words and/or one or more symbols.

The text message may include receiver information. The receiver information may indicate to whom the message will be sent. For example, receiver information may include cell phone number(s), user name(s), group name(s), public interface identifier(s) (e.g., an identifier of a public posting interface, such as a business and/or location public posting interface), an email address, a social media identifier, etc. The text message may be presented on a graphical user interface via a presentation interface of the user device, in some implementations. For example, a graphical user interface generated by the TTV app may present the text message in a field.

The text message or portion(s) thereof may be transmitted to the TTV server (operation 315). For example, the TTV app may transmit the characters and/or phrases of a text message to the TTV server via a network.

The text message or portions thereof may be analyzed (operation 320). For example, the phrases in a text message may be identified by analyzing the provided text message. The text message may be parsed and the phrases may be identified, for example, by spaces between characters. The phrases may be identified by comparison to phrases in a library (e.g., user library and/or public library). The analysis may identify which phrases are associated with video clips in the user's library and/or a public library. The analysis may identify which phrases are not associated with video clips in the user's library and/or a public library. For example, a user's library may be stored on a memory of the TTV server and associated with the first user's user information. When a text message is analyzed, the TTV server (e.g., a module of the TTV server) may access the user's library based on the user's information and compare the text message to phrases in the user's library. The analysis may be performed by the TTV app, the TTV server, and/or a combination thereof.

One or more indicia may be associated with one or more of the phrases in the text message and may be presented on the user device (operation 325). The indicia may include font, coloring, highlighting, flags, underlining, etc. In some implementations, predetermined indicia may be associated with phrases that are associated with video clips that are available in a user library, a public library, and/or not available in a library. For example, one or more indicia may be presented on an interface generated by the TTV app when a phrase is available in the user library and/or public library; and/or when a phrase is not available in the user library and/or public library. In some implementations, phrases available in the user library may be identified by a different color font than other phrases that are not available in the user library. The phrases may be identified by highlighting when a phrase is unavailable in the user library, in some implementations. Thus, the first user may be able to identify which phrases are associated with video clips and/or where the video clip is stored (e.g., public and/or user library). The first user may be able to identify which phrases are not associated with video clips based on the indicia presented with the text message on the TTV app.

If one or more of the phrases in the provided text message are not associated with video clips in the user's library and/or public library, the user may be allowed to provide a video clip to be associated with the phrase (operation 330). For example, the TTV app may prompt the user to provide and/or record a video via a banner, the indicia, and/or other notification. The TTV app may facilitate recording video clips through the use of frames, border shading, etc. Thus, when video clips are used to generate a video message (e.g., merged) the video message may appear to the user to have been recorded together rather than piecemeal. In some implementations, when a user declines to provide a video clip to be associated with a phrase not associated with a video clip in the user's library and/or public library, a video clip that includes an image of the word may be included. It should be appreciated that media including images, video, and audio corresponding to an individual word may be searched through a third party search engine and/or a proprietary search. It should further be appreciated that recommendations for selecting media may be based on other users' media assigned to the same individual word that the first user selects. It should also be appreciated that a user may save another users' media assignments for later use.

The identified phrases in a text message may be associated with video clips and/or video clips may be generated for the phrases (e.g., a video clip including the word). The video clips associated with the identified messages may be retrieved and a video message may be generated based on the retrieved video clips. The generated video message may be presented to the user (operation 335). The video message may be presented on an interface generated by the TTV app. The video message may be presented in a lower resolution than the resolution at which the video message will be transmitted (e.g., to speed download of the video message generated by the TTV server), in some implementations. The presented video message may be viewed, edited, deleted, and/or sent by the user via the TTV app. It should be appreciated that, after a word is typed into a user device, media associated with the word may automatically appear in the user's saved media. As such, the media that automatically appears may be selected to generate a video message. It should further be appreciated that different users may share media.

An approval message to transmit a video message based on the provided text message may be transmitted (operation 340). For example, the user may select a send button to provide an approval to send the text message. The TTV app may transmit the generated video message based on the receiver information. In some implementations, the TTV app may transmit an approval message to the TTV server and the TTV server may allow the generated video message to be transmitted based on the provided receiver information.

Process 300 may be implemented by various systems, such as system 100. In addition, various operations may be added, deleted, and/or modified. In some implementations, process 300 may be performed in combination with other processes such as process 200. For example, one or more of the phrases from the text message may be included in the generated video. In some implementations, one or more of the phrases from the text message may be transmitted with the generated video message for presentation. In some implementations, a text message may be provided in a different language than the language of the generated video message (e.g., a Mandarin video message may be generated based on an English text message). It should be appreciated that the video messages may be created in any desired language. It should further be appreciated that the video message may adapt settings based on different lengths of words and syllables of any desired language. In some implementations, the properties of the generated video message may be based on user (e.g., first user and/or other users to whom the video message will be presented) preferences. For example, user preferences may allow advertisements to be shown and/or not shown; allow use and/or may restrict use of a public library; include and/or not include the text message or portions thereof with the generated message; etc.

In some implementations, the generated video message may be presented to the user on the first user device. The generated video message transmitted to the first user device may be a lower resolution than the generated video message transmitted to the other user device(s) (e.g., the recipient of the message). For example, the user may preview the video and/or edit the video (e.g., change color effects, such as using sepia tones, using a black and white video, highlight a spectrum of colors, etc.).

In some implementations, receiver information associated with a text message may allow the generated video message to be displayed publically. For example, the generated video message may be posted to a social media site, user website, public posting interface accessible through the TTV app, and/or other public forum. In some implementations, the receiver information may allow the generated video message to be transmitted for presentation on a TTV app on a user device associated with a business and/or a location (e.g., via a public posting interface, on a map presented on the TTV app, etc.).

In some implementations, the receiver information may include an identification of a group of one or more users. The TTV app and/or the TTV server may retrieve receiver information associated with each of the members of the group identified in the receiver information and transmit the generated message to the members of the group.

In some implementations, the TTV app may generate a public posting interface. The public posting interface may allow presentation of generated videos. The public posting interface may allow messages on the public posting interface to be searched (e.g., based on group, sender, location, business, etc.), allow posting of comments (e.g., text comments, video comments, indications of whether the message was enjoyed or not enjoyed by a viewer), allow a number of views by other users to be presented, and/or other appropriate features.

In some implementations, the TTV app may generate and/or present analytics such as popularity meter(s) and/or other analytics associated with video messages on the public posting interface generated by the TTV app. For example, users may rate video messages on a scale (e.g., 1 to 5, 0 to 100, good to bad, blue to red, and/or funny to not funny). In some implementations, the TTV server may determine which video messages to present on the public posting interface and/or in which order the video messages are presented based at least partially on the analytics. For example, a public posting interface may identify the most popular video message for a time period (day, week, etc.). In some implementations, a public posting interface may be associated with a location and/or a business. Videos may be transmitted to the public posting interface via the TTV app.

In some implementations, the TTV app may allow geolocation information (e.g., from cell phone triangulation, from user provided location information, and/or from GPS) to be associated with the generated video message. The TTV application may associate geolocation information automatically and/or manually with the generated video message.

In some implementations, the TTV app may allow users to view video messages based on geolocation information. For example, a TTV may associate video messages with a business and/or location and a user may select the business and/or location from a map and view the video messages associated with the selected business and/or location.

In some implementations, the TTV app may provide users with recommended words for describing images, rather than generic words, based on geolocation information. In some implementations, the TTV app may provide users with recommended images and video based on geolocation information. For example, if the user is located in New York, typing the word “bridge” may generate an image of the Brooklyn Bridge, and if the user is located in San Francisco, typing the word “bridge” may generate an image of the Golden Gate Bridge.

In some implementations, the TTV app may generate a notification to alert users that their geolocation is near a location where other users have been more active than the average activity at a location. For example, a user located where several other users may have captured images and assigned words to those images may receive a notification.

In some implementations, the TTV app may allow generation of quick messages. A predetermined quick message (e.g., “can't talk-driving”, “in a meeting, call you later”, “see you soon”) may be a phrase that a user may select to send. The user may customize the predetermined quick message and/or select a predetermined quick message from a library (e.g., text to associate with a video recorded by the user and/or a video from a public library). For example, the user may associate the quick message with a video (e.g., still and/or moving images). The user may select a quick message via an interface of the TTV app and may provide receiver information. Thus, the user may not need to provide the text message but rather select a quick message, in some implementations. In some implementations, a quick message may be utilized to convey tone or an emotion. For example, a mean quick message may include a video of the user making a mean face. A funny quick message may include a video of the user laughing.

In some implementations, the TTV app may share and automatically populate pre-selected words or words that are most frequently assigned to images. For example, the TTV app may recommend to a user “You are in a location that is popular for creating video messages. See what words are being used the most.” The user may view new words that may be added as recommended words to use to describe images that capture the environment in which the user is located. For example, if the user is located at a popular beach and several users have created video messages from the same beach, then the most common words assigned to the beach may populate in a list. It should be appreciated that video messages may be shared among users within a particular geolocation. It should further be appreciated that users within a particular geolocation may save the most common shared words as their own words. The most common borrowed words may be generated in a ranked list and shared among users.

In some implementations, a public library may include paid content to which a user pays for access (e.g., monthly, annually, per use). For example, celebrities (e.g., people, animals, and/or animated characters) may provide video clips as paid content that users may utilize in generated video messages. In some implementations, paid content may include symbols, logos, and/or other copyrighted material to which the user gains access for inclusion in generated videos. In some implementations, users may provide video clips that others may pay to access and utilize in their video messages.

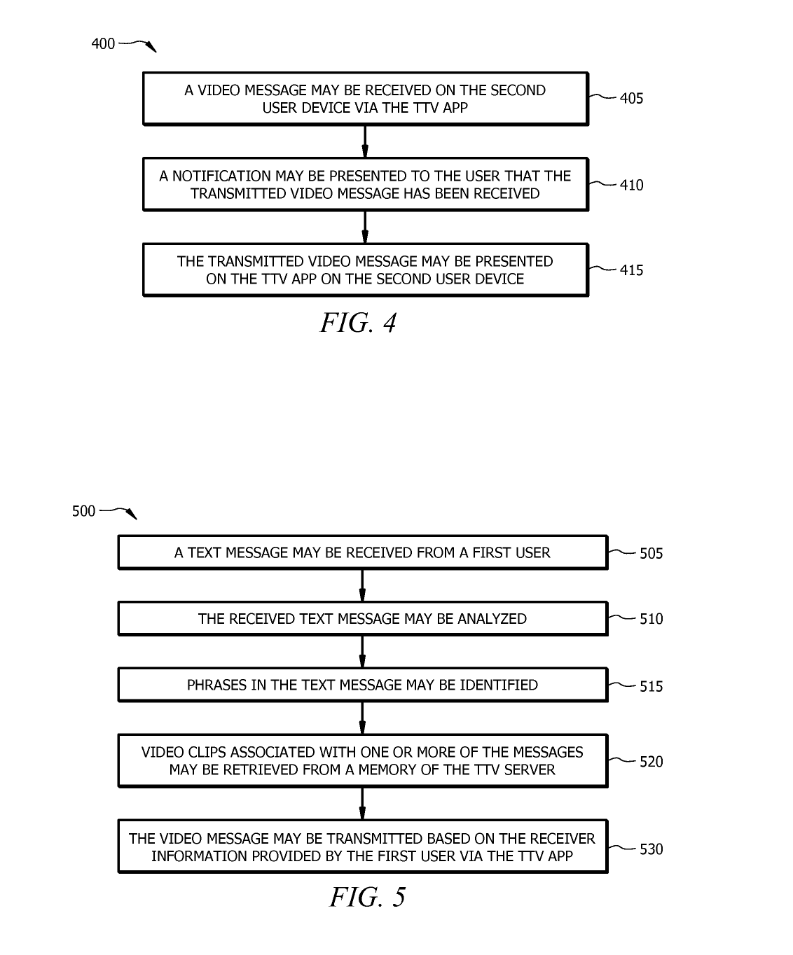

After a first user provides approval to transmit to other user(s) a video message based on a text message provided by the first user, the other user(s) may receive the video message. FIG. 4 illustrates an implementation of an example process 400 for receiving a video message.

A first user may transmit a video message (e.g., via a provided text message) to other user(s), such as a second user, via the TTV app. The second user may have a second user device. The second user device may include a memory on which the TTV app is stored. The processor of the second user device may retrieve the TTV app and execute one or more of the instructions of the TTV app to perform operations of the TTV app. In some implementations, the second user may download the TTV app, updates to the TTV app, and/or add-on features to the TTV app, to the second user device from an app marketplace, such as App Store, Google Apps Marketplace, Google Play, Amazon Appstore, etc.

A video message may be received on the second user device via the TTV app (operation 405). For example, a video message may be generated (e.g., by the TTV server and/or the TTV app on the first user device). The generated video message may be transmitted based on receiver information (e.g., provided by the first user) to the second user device. The video message may be transmitted to the TTV app on the second user device.

A notification may be presented to the user that the transmitted video message has been received (operation 410). For example, a new mail notification (e.g., auditory, tactile, and/or visual notification) may be generated by the TTV app and, for example, presented on the second user device. In some implementations, a new message audio signal may be generated by the TTV app.

The transmitted video message may be presented on the TTV app on the second user device (operation 415). For example, the video message may be presented on an interface generated by the TTV app on the second user device. The second user may select (e.g., select the message from a listing of messages, select a play button, etc.) the message to allow the video message to play on the interface generated by the TTV app. In some implementations, the transmitted video message may automatically play (e.g., when the TTV app is open, when the second user is logged into the TTV app, based on user preferences, etc.).

Process 400 may be implemented by various systems, such as system 100. In addition, various operations may be added, deleted, and/or modified. In some implementations, process 400 may be performed in combination with other processes such as process 200 and/or 300. For example, the second user may respond to the video message with a video message, a text message, an audio message, and/or a video message generated based on a text message provided by the second user. The second user may forward the video message to one or more users. The second user may alter (e.g., make shorter, add-on to, etc.) the video message and reply to the first user and/or forward the message to other user(s). For example, a first user may send a message to a second user, such as “let's meet up at 9”, the second user may alter the message to say “let's meet up at 9 at the bar on J street” and reply to the first user and forward the message to a third user. Rather than generating the video message based on the second user's library, the altered message may include a first part from the text message provided by the first user and a second part from a text message provided by the second user. Thus, the third user may view a video message that includes the first user saying “let's meet up at 9” and the second user saying “at the bar on J street.” In some implementations, the second user may forward the video message and/or an altered video message to a public post interface.

In various implementations, the TTV app on user devices may communicate with the TTV server to allow generation of video messages based on text messages. FIG. 5 illustrates an implementation of example process 500 for generating video messages based on text messages.

A text message may be received from a first user (operation 505).

The received text message may be analyzed (operation 510).

Phrases in the text message may be identified (operation 515). For example, the text message may be parsed (e.g., based on spaces, symbols, punctuation, etc.). In some implementations, the phrases may be identified based on phrases in the user library and/or public library. In some implementations, language analysis technology may be utilized to identify phrases. Further, a message may be transmitted to the user related to which phrases in the text message are associated with video clips in a memory of the TTV server.

Video clips associated with one or more of the messages may be retrieved from a memory of the TTV server (operation 520). For example, video clips may be retrieved from a public library and/or a user library. In some implementations, a user may be requested to provide a video clip for a phrase and the TTV server may receive the video clip to associate with a phrase. The video clip and the association may be saved in a library (e.g., user library and/or public library).

A video message may be generated based on the retrieved video clips (operation 525). In some implementations, a phrase may not be associated with a retrieved video clip and/or a user may not provide a video clip to associate with a phrase. The video message may include a still and/or moving image of the word in place of a retrieved video clip (e.g., of a person saying or signing the word).

The video message may be transmitted based on the receiver information provided by the first user via the TTV app (operation 530). In some implementations, the video message may be transmitted to the first user device. A user may approve the message for transmission and the TTV server may receive an approval message from the TTV app. The TTV server may transmit the video message to other users after receiving the approval message.

Process 500 may be implemented by various systems, such as system 100. In addition, various operations may be added, deleted, and/or modified. In some implementations, process 500 may be performed in combination with other processes such as process 200, 300, and/or 400. For example, in some implementations, the TTV app may transmit the video message based on the receiver information rather than the TTV server.

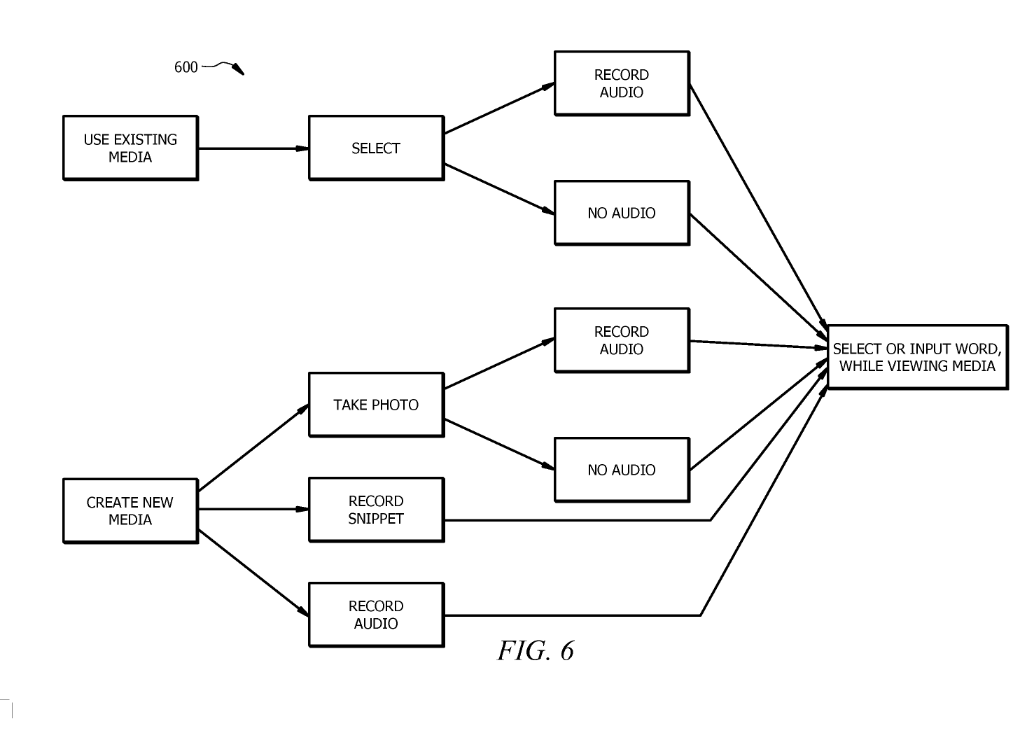

Referring to FIG. 6, in some implementations, application 600 including, but not limited to, a camera application may allow a user to view media and add an associated word(s) to the media before incorporating the media into a video message. It should be appreciated that the images associated with the added word(s) may automatically appear after typing the word(s) without departing from the method and system described herein. It should further be appreciated that the word(s) being assigned to an image may be displayed while the user selects the image. Further, it should be appreciated that any application used to add media to a user device may be integrated into the method and system described herein.

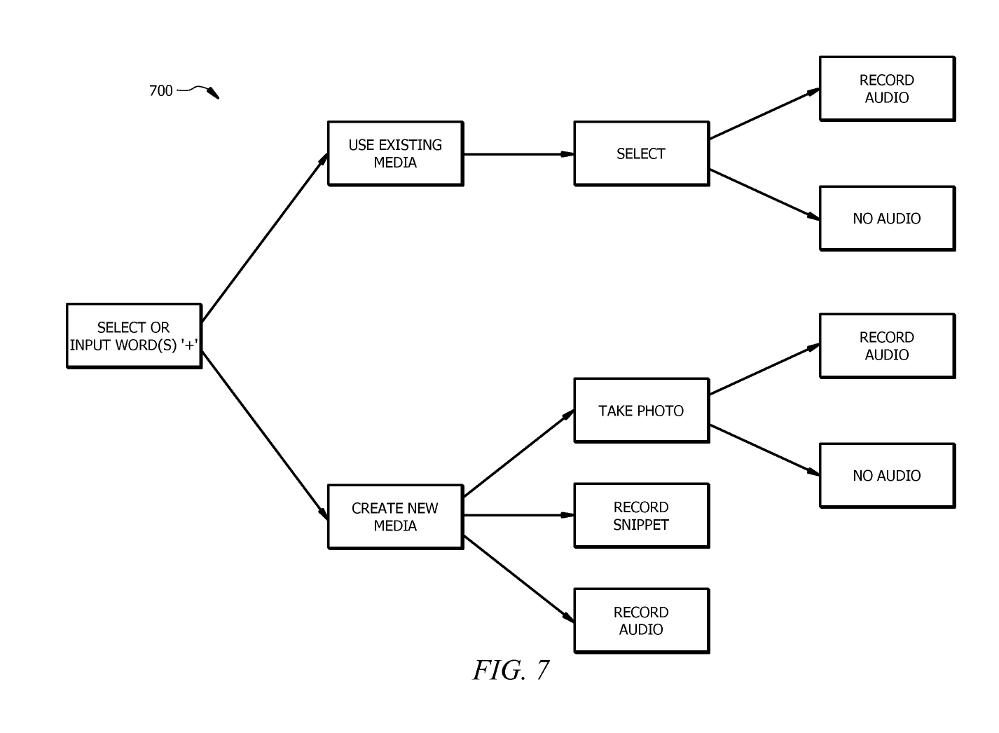

Referring to FIG. 7, in some implementations, by shifting a user interface flow, the user may be presented with a word(s) and/or allowed to input a word(s) into a user device before selecting any media to incorporate into a video message. As such, a reverse method and system of generating video messages 700 may occur including allowing a user to select a word, presenting the user with a camera, allowing the user to take a picture, and then allowing the user to assign the word to an image. It should be appreciated that the user may shoot a video, record audio, or any combinations thereof without departing from the method and system described herein. It should also be appreciated that words or characters may be directly written over and assigned to an image, video, and/or audio to provide clarity of what the user would like to convey in a video message.

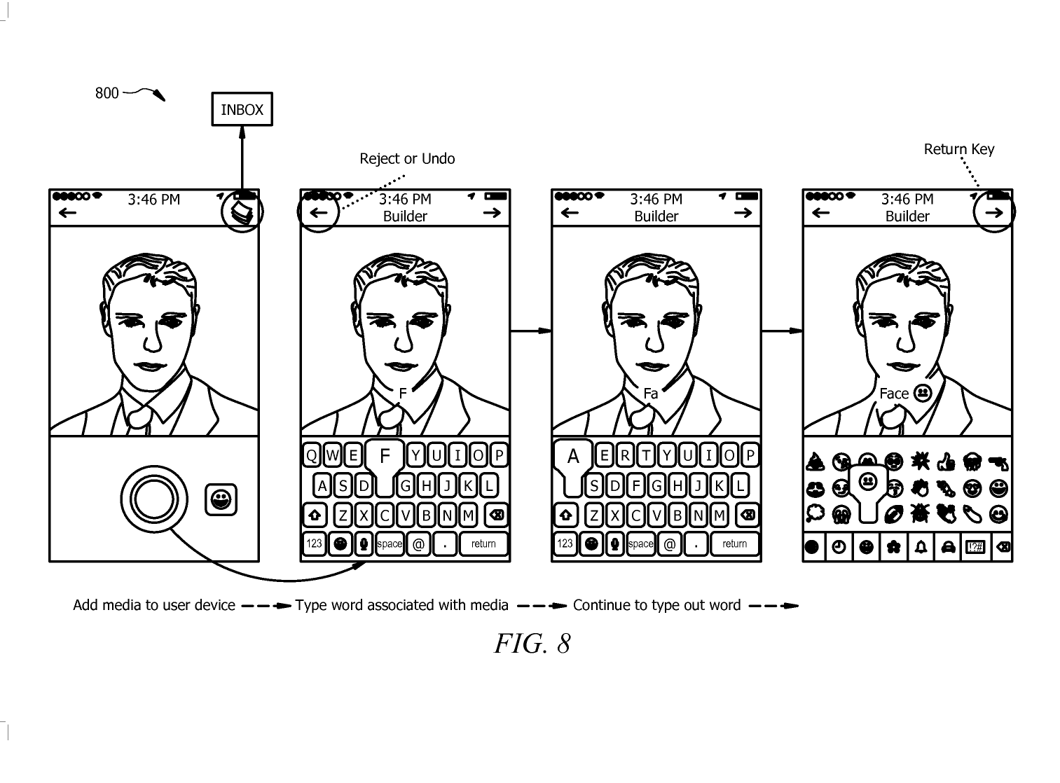

As shown in FIG. 8, according to an embodiment of the present disclosure, an exemplary method and system of generating a video message 800 includes adding media to a user device. After media is added to the user device, a user may select in what area a word(s) may be placed in order to describe the media. The user may add additional media, characters or symbols after typing a word(s) to be associated with the media. It should be appreciated that a user may input both media and a word(s) into a user device in a significantly short time period. It should further be appreciated that the user may choose and select a number of actions while inputting media and a word(s) into a user device including, but not limited to, accept, reject, move forward, undo, and go back.

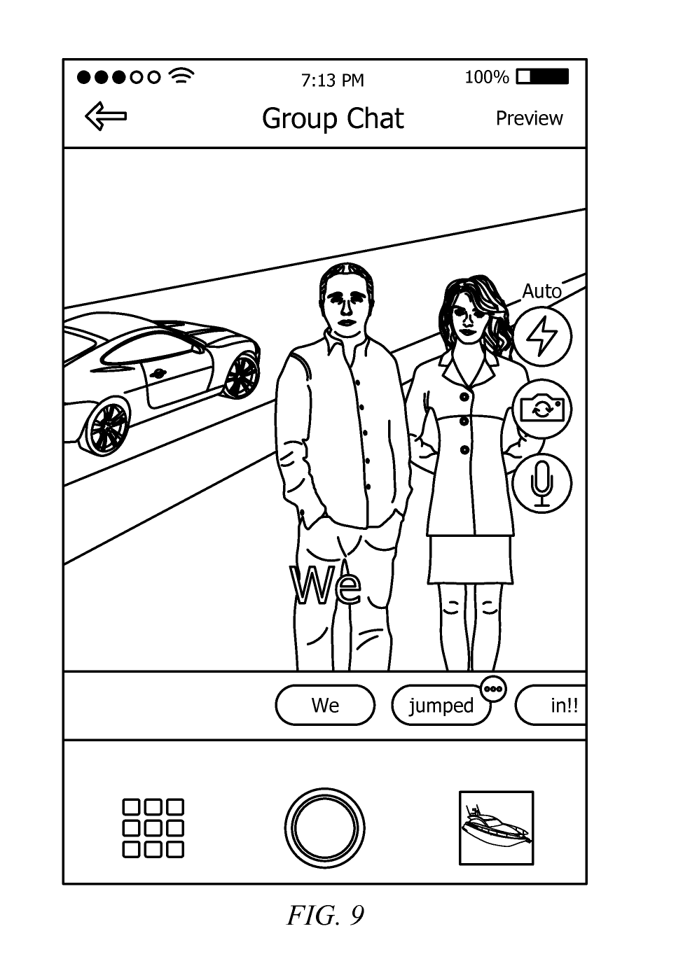

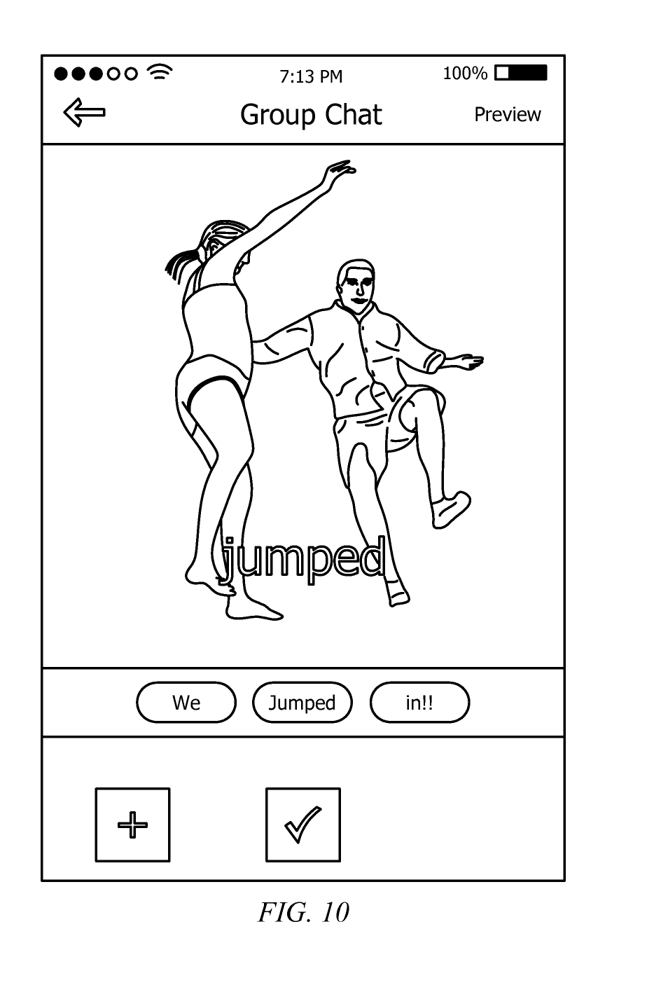

As shown in FIG. 9 and FIG. 10, according to an embodiment of the present disclosure, an exemplary method and system of generating a video message allows a user to associate words with images. For example, as shown in FIG. 9, a user may associate an image of individuals with the word “we,” and as shown in FIG. 10, the user may proceed in generating a video message on a user device by associating the word “jumped” with an image showing the same individuals having their feet off of the ground.

In some implementations, advertising may be transmitted to other users (e.g., recipients) in and/or approximately concurrently with the generated video message. The advertising may be displayed in the TTV app on a user device as text, video, etc. The advertising may be presented next to video messages (e.g., top, bottom, and/or side(s)) and/or in video messages. The advertising video may be inserted into generated video messages, as appropriate (e.g., beginning, end, in the middle, replacing phrases of the message).

In some implementations, a generated video message may include an advertisement inserted in the generated video. For example, one or more phrases in a provided text message may be identified. Rather than retrieving a video from a public and/or user library, an advertising video may be retrieved. The advertising video may say the phrase and/or present an image associated with the phrase. For example, a pizza restaurant may provide an advertising video that says pizza while displaying the pizza restaurant logo. Thus, when a user provides a text message such as “let's get pizza.” The generated message may include video clips from the user's library for “let's” and “get” and an advertising video for pizza. In some implementations, a video with an image of a pizza or an advertiser's logo may be inserted before and/or after the retrieved video clip for pizza. The generated video with the advertising video may then be transmitted to other user(s).

In some implementations, the receiver may be able to select (e.g., click) the advertising video and/or a link proximate the generated video message to access information related to the advertiser (e.g., company website, menu, hours of operation, map of company location, reservation system, telephone number).

In some implementations, the advertising video selected to be transmitted to the user (e.g., to be presented in the generated video and/or proximate the generated video) may be based on user preferences (e.g., opt out of advertising, how user would like to receive advertising), geolocation information, phrases in the provided text message, phrases in the user library, etc. For example, if a user's library does not include a video associated with a phrase in a provided text message, then an advertising video may be utilized. Advertising videos may include still and/or moving images (e.g., logos, product placement, etc.), text (e.g., alphanumeric characters and/or symbols such as emoticons), hyperlinks, and/or other appropriate content. In some implementations, an advertising video selected may be based at least partially on geolocation information of the first user and/or other users (e.g., recipients). For example, if a text message provided includes “let's get pizza”, a geolocation of the first user and/or other user (e.g., to whom the message will be transmitted) may be utilized to select an advertising video associated with an advertiser proximate the first user and/or the other user. In some implementations, an advertiser may select locations in which an advertising video may be presented to users.

In some implementations, a first user may be notified that the generated message includes and/or will be presented with an advertising video.

In some implementations, an advertisers logo may be displayed proximate a generated video message in a user's inbox.

In some implementations, a user's browsing history may be utilized to provide advertising videos. For example, if the user browsing history indicates that the user visits specific retailers, such as restaurants, the advertising videos selected by the TTV server to be presented to the user may be based on the browsing history, such as the specific retailers that the user visits on the internet.

In some implementations, the advertising video(s) and/or other messages from the advertisers may be presented on interfaces of the TTV app. In some implementations, advertisers may provide video clips in the public library and a user may select advertising videos to include in generated video messages.

In some implementations, the TTV server may allow other users, such as developers, to provide features to be added on to the TTV app and/or paid content for public libraries. Users may search through the TTV app for add on features, free content, and/or paid content. The TTV app may include an interface that displays popular add-on features and/or paid content. The user may access the paid content and/or add-on features via an app marketplace, in some implementations.

In some implementations, the TTV app may include Add-on Features (In-App Purchases) that may be integrated into the TTV app. The user may be able to include the content of these add-ons into their future generated videos. These add-ons may include features such as symbols, videos of celebrities, a n d videos of cartoon characters. The TTV may have a marketplace (e.g., accessible via the TTV app and/or an app marketplace) at which users may be able to find and download add-on features. The add-ons may be free and/or available for an additional fee to download. The market place may include a search feature that allows the users to have the ability to search for available add-ons for the TTV app. The marketplace may display certain add-ons based on popularity. The TTV app may allow users and/or developers to create customized add-on features for the TTV app that may be made available for download (e.g., for free and/or for an additional fee) in the market place. In some implementations, the user may be able to purchase the add-on feature by using an account, such as Apple iTunes® Google Play® accounts, for example.

In some implementations, the TTV server may allow advertising rights to be purchased by third party advertisers and/or viewed in the TTV app. For example, the TTV server may allow specified words (e.g., phrases) to be available to participating advertisers to purchase. The TTV app may use one or more various methods to present the advertisement. The TTV app may present the advertisements in the form of text on an interface generated by the TTV app (e.g., at the top, bottom, or sides of the message recipients' screen). The textual advertisements may be in the form of streaming banners. The textual advertisements may be in the form of a short message. The textual advertisement may include the advertiser's logo. The TTV server may add the advertiser's video into any appropriate portion of the sender's message. The message recipient may have the ability to click on or otherwise select the advertisement which will take the user directly to the advertiser's website in the user's internet browser.

The third party advertiser may pay through a TTV server based on how many times their word was used, therefore how many times their advertisement was seen by end users. The advertiser may pay a fee each time a user clicks on the advertisement and the user is sent to the advertiser's website. The fees charged for certain words may be based on a word's usage. Advertisers may be able to choose words for to display varying amounts of time (e.g. 1 hour, 1 hour, 1 day, 1 week, and 1 month). The TTV server may change the fee for each particular word based on desirability of participating advertisers, in some implementations.

The TTV app and/or TTV server may use the user's current location at the time of receiving the message to determine which advertisement the user will see. The TTV app and/or the TTV server may use the user's area code to determine which advertisement the user will see. The TTV server may make words available to third party advertisers on international, national, regional, state, and local levels. The third party advertiser may select a geographical level at which the chosen word may display their advertisements. Prices may vary based upon the advertiser's desired geographical level, in some implementations. The TTV server may allow different advertisers to simultaneously advertise the same word at different geographical levels, in some implementations.

The TTV app may include application settings that allow a user to choose a method of receiving advertisements (e.g., from a listing of options). The TTV app and/or TTV server may notify the sender that the video message transmitted based on the user's provided text message may include an advertisement. In some implementations, the TTV app may present an advertiser's logo in a user's inbox next to each message string. The TTV app may access the user's web browser history in order to provide relevant advertisements, in some implementations. The TTV app and/or TTV server may allow advertisers to display advertisements on a web page generated by the TTV server. The TTV server may allow advertisers to select characters, such as words, symbols, and/or emoticons. The TTV app may allow users to pay a fee (e.g., annual fee) in order to restrict receipt of advertisement in the user's TTV app and/or in video messages generated by text messages provided by the user.

In some implementations, the TTV app and/or TTV server may allow user(s) to view video messages posted to public posting interfaces based on a location from which the video messages were sent. In some implementations, the TTV app and/or TTV server may be displayed (e.g., overlaid) on a map application software (e.g., Google Maps® and/or Apple Maps®) on the user device. The TTV app may use the map in the map application software to display the location of the messages on the map. In some implementations, the TTV server may allow businesses to create their own accounts and the TTV app may display the business's location on the map (e.g. in the map application software) using the business's physical address. The TTV app may allow users to indicate that they are at a particular business and/or location. The TTV app may allow a user to indicate the location from which they creating the video message and/or automatically determine a location from which the text message was provided.

In various implementations, users may make their video messages, make video clips public, transmit video messages, and/or transmit video clips to a public posting interface. Public video messages may be added to a group (e.g., a group posting interface, to group member TTV apps, etc.) by using numbers. The TTV app may allow users to post their public message to a location's or a business's public posting interface. The TTV server may generate a website that may display the public messages, in some implementations. The TTV server and/or TTV app may allow users to search through public messages based on which group, location, or business to which they were posted. The TTV server may include a chat feature that allows communication and/or comments on other users video clips and/or video messages. The TTV app (e.g., interfaces generated by the TTV app) may display a count of the amount of times a user's video message and/or video clip has been viewed. Publically posted video messages and/or video clips may be presented on interfaces generated by the TTV app on user devices.

In various implementations, video messages may be sent to any user and be viewed by any user. It should be appreciated that the recipient of a video message may view the video message whether or not the recipient views the video message from an application that includes the method of generating a video message. It should further be appreciated that the recipient may view the video message on any device or download an application to view the video message.

In some implementations, users may save video messages including various images, video, and audio without being required to share the messages with someone else or post the message to a third party service, including, but not limited to, social media outlets. However, it should be appreciated that a user may create a video message and share the message with a third party service without departing from the present disclosure. For example, a user may generate a video message and generate a symbol including, but not limited to, “#” or “@” along with an appropriate handle or identifier to share the video message with users on a third party service including, but not limited to, Facebook® and Twitter®.

In various implementations, TTV app may allow users to send anonymous video messages generated from provided text messages. The recipient may receive the anonymous video message which will indicate that the sender is anonymous. TTV server and/or TTV app may allow the user to guess the identity of the sender from their contacts. TTV server and/or TTV app may allow the sender to designate the amount of guesses that the recipient will have before the user's (e.g., sender's) identity is revealed. TTV server and/or TTV app may designate the amount of guesses that the recipient will have before the sender is identified. TTV server and/or TTV app may allow the recipient an unlimited amount of guesses to identify the sender. TTV server and/or TTV app may allow the sender's anonymous message to remain anonymous.

In various implementations, the TTV server and/or TTV app may provide promotions for the user on their birthday. In some implementations, promotions may include free and/or discounted downloads of add-on features and/or other in-app purchases. The TTV server and/or TTV app may allow users to select several of their favorite brands and business, and the TTV server and/or TTV app may allow the selected advertisers to send users promotions on their birthdays.

In various implementations, the TTV server and/or TTV app may allow seamless copying and pasting of video clips (e.g., moving images and/or still images, such as photos) and/or video messages from a web browser on the user device to the TTV server and/or TTV app messages. TTV server and/or TTV app may incorporate a clipboard into the users' browser that allows communication with the TTV server and/or the TTV app. TTV server and/or TTV app may automatically convert a URL that links to video clips into a correlating video clip (e.g., without an additional clipboard).

In various implementations, the TTV server and/or TTV app may ask users for permission to use their microphone, cameras, user locations, social media logins (e.g., Facebook information and/or Twitter information), contacts information, push notifications, access user emails in order to identify any other users that have emailed and/or been emailed and also have the TTV app on user devices.

In various implementations, the TTV server and/or TTV app may allow creation of and/or designation of an existing a ringtone to notify recipients of a received video message and/or transmission of a video message. TTV server and/or TTV app may allow creation of multiple ringtones and may allow users to choose their ringtone within the settings of the TTV app, in some implementations.

In various implementations, the TTV app may identify when a user device is in a silent mode. When a user device is in a silent mode, a message may be viewed without the associated audio, in some implementations. Instead of hearing the audio in the video, the provided text message may be displayed while the video message is presented.

In some implementations, the TTV server and/or TTV app may include a feature that allows users to report any unwanted, inappropriate, and/or illegal messages. TTV server and/or TTV app may delete a user found to be guilt of transmitting the message in question. TTV server and/or TTV app may choose to report the user to law enforcement if the message contains illegal content. TTV server and/or TTV app may store deleted users' information in order to identify them and keep them from creating new accounts. For example, information may include the MAC addresses of the devices, IP addresses they have used, their listed phone number, and their listed email address, in some implementations.

In some implementations, the TTV server and/or TTV app may incorporate a feature that may allow users to block incoming messages from specific users. TTV server and/or TTV app may notify the sender that their message has been blocked. TTV server and/or TTV app may not notify the sender that their message has been blocked.

In some implementations, the TTV server and/or TTV app may provide visual effects that may allow the users to alter their videos and photos to be used in their message. Effects may include, for example, items such as hats, facial hair, glasses etc. TTV server and/or TTV app may utilize facial recognition to allow the desired visual effects to remain in the desired placement on the user's face regardless of movement.

In some implementations, the TTV server and/or TTV app may also provide editing tools which allow users to alter their videos and photos to be used in their messages. Tools may include, but are not limited to, a drawing tool that may allow users to draw lines on their photos and videos and/or a tool that may allow users to distort their videos and photos.

In some implementations, the TTV server and/or TTV app may include a feature that may automatically recognize words from previously recorded video clips and allow users to use those words in their TTV server and/or TTV app library/vocabulary. The user may use this feature for video clips from their own video clips stored on their user device or from videos downloaded from the Internet. This feature may play the video and simultaneously recognize each word, in some implementations. The TTV app may display one or more of the words from the video and allow the user to select which words they would like to add to their library/vocabulary. The words that are selected to be added (e.g., to the user library) may be associated with the portion of the video (e.g., to form a video clip) in which that word is spoken.

In some implementations, when users use the TTV app for the first time, the user may type out a message. As the message is written, each word may appear with a stylized ‘box’ (e.g., red box, etc. such that the color may identify the status, such as associated with a video clip, of a particular phrase) outlining each individual word. After typing the message, the user may press and continue to hold any red ‘boxed’ word and a built in camera application will automatically appear on screen. The video clip may be recorded by a front facing camera or a rear-facing camera, in some implementations. This newly created video clip may be associated with the specific phrase. This phrase may now be highlighted by a new indicia, such as a green outline, or ‘box’ to indicate that the phrase does have an associated video clip.

In some implementations, the user may isolate and/or identify an element including, but not limited to an image, video, audio, or word in a video message. The user may replace the isolated and/or identified element with a new element. For example, a user may generate a video message using video, audio, and the word “go,” and the user may replace any element within the video message. If the audio includes a recording of someone saying the word “jump,” then the user may replace the audio with a new recording of someone saying the word “higher.” The audio recording of the word “higher” may then be heard when viewing the video message instead of the original recording of the word “jump.” However, the original video and the recording of the word “jump” may not be adjusted or manipulated. It should be appreciated that the updated video message may be saved in a library for future use. It should further be appreciated that the new audio may be saved and later assigned to another word, image, or video. In some implementations, the audio may be saved and later assigned to another image or video.

In some implementations, the TTV app may include features to facilitate recording of video clips such that when the video clips are merged into a video message a predetermined effect may be achieved (e.g., consistent or inconsistent user location). For example, a count down timer may appear and quickly count down to let the user know they are about to be filmed. Over the next second or other predetermined time allotment, the user may be recorded saying or acting out the highlighted phrase to which they are associating the video clip. A small progress bar may appear at the top of the screen to show how much time is remaining in their predetermined time allotment. During the recording, a frame may appear in the center of the image being recorded. This frame, (e.g., ‘sight’, shaded border), may allow the user to keep the focal object more centered than without the frame. Centered content may facilitate creation of a video message with a more comprehensible ‘rhythm’ while watching the video message (e.g., when the video clips are strung together). The recorded images may be more centered on the focal content by displaying a frame or not centered at all by a frame, in some implementations. For example, interest in a video generated may be enhanced with smoother transitions and/or more erratic transitions. Facial recognition and/or object detection may also identify and center and/or uncenter an image on a determined focal point.

In various implementations, a separate method may be used to take a picture of a static image than may be used to record video with a predetermined or user adjustable timeframe. It should be appreciated that separate buttons may be used to record video and capture photos. In some implementations, generating video messages may include detecting a gesture that may indicate a desire to capture an image, video, or audio. It should also be appreciated that a user may swipe down or swipe up on an active image where words are overlaid to initiate swapping between photo capture and video capture.

In some implementations, the format in which the video clip and/or video message is generated may be based on TTV server instructions, user preferences, and/or alterations provided by the user. For example, the video message and/or video clip may include fade in, fade out, and/or other special effects. Transitions (e.g., the way that one image or video that is assigned to an individual word, is led into the next image/video assigned to the next individual word, within a message sequence) may be altered by the user and/or TTV server, in some implementations. Transitions may display no effect, no break, and/or perform a break between images, in some implementations. Transitions may include, but are not limited to, quick fade out/fade in, an effect that ‘wipes’ the first image away to reveal the next, etc. For example, audio of two video clips running concurrent to each other in a video message may be overlaid or paced in the video message and any fade in, fade out, or breaks may be unnoticeable to users. If a transition is used with the overlaid audio, a more seamless video message may be created. It should be appreciated that if only 0.05 seconds were overlaid on the front and the back of each video clip, then the overlaid audio may reduce a ten second video message by one second or ten percent. It should further be appreciated that the overlap of video clips in a video message may be increased by 15%, 20%, or 25%.

In some implementations, overlaying audio may reduce the number of punctuation marks. It should be appreciated that each punctuation mark may require approximately one second in duration to view, speak, or hear in a video message.

In some implementations, the duration of the video clip may be based on the amount of audio that may be recorded. In these implementations, detecting when a user begins saying a word and completes saying the word may occur. It should be appreciated that any dead air time or portions of the video message without any audio may automatically be eliminated. It should further be appreciated that the average person may speak 160 to 190 words per minute.

In some implementations, overlaying audio or pacing may be affected by the character count of the word in the video message itself. As such, long words and syllables exceeding an allotted time period may be eliminated by counting characters in the word, in order to gauge the approximate length of time that is required to say, read, and/or listen to the word. For example, “probably” contains eight characters and requires considerably more time to say, read, and listen to than the word “is” which only contains two characters. In some implementations, users may record a word that may occupy slightly longer than or less than a set time frame. For example, if the user says “California,” then the user may require more time to properly annunciate the word than saying “a” which requires less time to annunciate. A user may simply press and hold down a record Audio/Video shutter button and release the button after speaking an intended word. It should be appreciated that a separate button for recording audio and/or video may be required, as opposed to a hybrid shutter button that may require multiple steps including tapping to take a picture and pressing and holding down the button to record a video.

In some implementations, a video clip may be recorded and/or displayed in a square format, in a to-be-determined ratio, and/or a format where height and width are identical and linked including when sized differently for different devices, in some implementations. The TTV app may allow support for more than one video playback options and/or formats, in some implementations. The TTV app may allow recording and/or play back of video of differing styles. The video clips may be displayed or recorded in ‘wide’, or a taller, vertical format, for example.

In some implementation, when a message is sent and a phrase is not associated with a video clip, the phrase may float over a black or other image to create a video clip that may be utilized in a generated video image. This may maintain a cohesive viewing experience for the intended recipient.

In some implementations, if multiple words or a phrase are to be used for a single image, the user may have the option to modify the length of the video to better accommodate the length of the recording, since it may require more recording time than the default recording length set by TTV app.

In some implementations, when characters are used to emphasize certain emotions, such as an exclamation point or question mark (!) or (?), the TTV app and/or server may automatically indicate that desired emotion and display it within the video message, beyond that character simply having its own image assignment stuck to the end of the message. For example, if a sentence ends in an exclamation point, the software may be aware that the tone of that entire sentence is one with more emphasis or excitement. To denote this, the video that is played for that particular sentence may have a certain hue or color overlaid throughout that video message, perhaps it is slightly red for example. For example, a question mark may be green, etc. In some implementations, the TTV app may apply the effect (e.g., certain hue or color overlay) to the last image/word of the video message and/or the frame before the character (e.g., exclamation point or question mark) at the end of the message.

In some implementations, the TTV app may allow a user to manage privacy settings. As users are creating their libraries of words, for example, there may be some images created for certain words that may not be appropriate for all the contacts of that particular user. The TTV app may include an option for a video clip being recorded to be tagged as ‘Private’ or ‘Sensitive’ and/or the video clip may be tagged later. This particular image may be easily incorporated into a video message and sent out to recipients. For example, if an image is used that is tagged as ‘Private,’ the color of that word may change to something unique to alert the user that a sensitive image is within the body of what may be written. In some implementations, a slight vibration or other indicia may trigger the device to alert the user. In some implementations, other indicia in using tagged phrases, such as words, may include pop-ups and a password prompt. The safe guard controls for private tagged video clips may be accessible in the settings menu of the TTV app and the user may manage the settings and/or the indicia presented. It should further be appreciated that a user may mark media as shared or not to be shared” in order to protect the privacy of the user's media content.

### EXAMPLES

### Example 1

In various implementations, the TTV app may generate one or more graphical user interfaces to facilitate input, receipt, and/or presentation of information related to transmitting video messages generated based on received text messages. FIGS. 8 to 10 illustrate implementations of example implementations of graphical user interfaces generated by the TTV app.

### Example 2

In various implementations, the TTV app and/or the TTV server may allow users to assign different images to the same word (e.g., for homonyms). For example the word ‘club’ has two different meanings. When the user types a homonym, the word may become a specified color question mark (?), alerting the user that there may be a conflict in its interpretation of that word. When pressing and holding that word, instead of the camera application appearing, it may first display the two words with a simple definition assigned to each, to indicate which word represents which meaning. The user, while continuing to hold the highlighted word, may drag their finger to a definition that is correct for the context they are trying to achieve. This feature may be presented as a circle, showing words along a spoke of a wheel. This may maintain symmetry and regularity within video messages.

Once the finger has been ‘hovering’ over the desired definition for a predetermined period of time, that definition may be selected for the word that is intended for use. If there is no image recorded, the camera application may automatically appear and film the desired video clip. If an image has already been created for that word, a previously recorded image may be selected. In some implementations, if an image has already been created for that word, ‘live’ tiles above the depressed word in question may be displayed. Sliding the finger up to highlight the desired usage may select that specific video to be used in the current message.

For example, when typing the word ‘club’, the user may be alerted that (e.g., by way of a unique color box outlining the word club, or a simple vibration, etc.) the library includes two previously recorded versions of this word. The user may simply press and hold the word club and two tiles may appear side by side above the word. The tiles may be presented live (e.g., the recorded video clip may be displayed in two windows on the TTV app). In some implementations, the other information on the interface at that time, besides the two images in question, may be slightly grayed out, to help focus the user's attention on the issue of selecting the correct image.

The user may slide their finger up and over the desired image and release and that selected image. As such, the image may be used when sending the message to their recipient.

The TTV app may use smart predictive software to try to anticipate the correct usage for a typed homonym. For example, the user may type ‘I gained a pound’. The software may recognize that this is more than likely referring to pound in relation to weight. And in turn, a sentence like ‘I made a Pound’ may be determined to refer to a British Pound the currency because of the sentence structure and the fact that Pound is sometimes capitalized.

### Example 3

In various implementations, the TTV app and/or the TTV server, currently available technology, and proprietary technology may recognize a subject or an object within media. For example, a user may take a picture of a pencil. The shape of the object may automatically be recognized, and a word may be provided to describe the object. In this case, the word “pencil” may be provided and displayed to the user. If the word “pencil” is appropriate for what the user would like to convey through media, the user may select the word for use and may assign the word to a particular image; here, the pencil.

In some implementations, as the user types a word, a list may be populated including words that the user has already assigned to images. It should be appreciated that stock images, video, or audio may or may not be included along with the list of populated words.

Although specific user devices and servers have been described in FIG. 1, the user device and/or TTV server may include any appropriate computer or other programmable logic device without departing from the present disclosure. The computer may include a processor that executes instructions (e.g., modules) and manipulates data to perform operations of the computer. Processor may include a programmable logic device, a microprocessor, or any other appropriate device for manipulating information in a logical manner and memory may include any appropriate form(s) of volatile and/or nonvolatile memory, such as RAM and/or Flash memory.

The memory may include data, such as libraries of video clips, modules to perform various operations, and/or any other data useful to the operation of the computer.

In addition, various software may be stored on the memory. For example, instructions (e.g., operating systems and/or other types of software) and/or modules may be stored on the memory of the computer. The modules may include the TTV app stored on the user device and/or modules in the TTV server to perform operations of the TTV server. For example, the TTV app may be executed by the processor of the user device to receive text messages, record video clips, transmit text messages and/or video clips to the TTV server, communicate with the TTV server, and/or other operations. The modules of the TTV server may be executed by the processor of the TTV server to receive text messages, analyze text messages, retrieve video clips, generate video messages based on retrieved video clip(s), transmit video messages, and/or other operations. The modules may perform one or more of the operations in processes 200, 300, 400, 500, 600, 700, portions thereof, and/or combinations thereof.

In some implementations, modules may be combined, such as into a single module or multiple modules. For example, the TTV app and/or modules of the TTV server may be distinct modules. In an implementation, the TTV app and/or TTV server modules may include various modules and/or sub-modules.

A communication interface may allow the computer(s) to communicate with other components of the system. The communication interface may transmit data from the other components of the system and/or receive data from other components, other repositories, and/or other computer systems via network protocols (e.g., TCP/IP, Bluetooth, and/or Wi-Fi) and/or a bus (e.g., serial, parallel, USB, and/or FireWire). Operations of the TTV app may be stored in a memory of the user device and may be updated and/or altered through the communication via network protocols (e.g., remotely through a firmware update, for example, available through a download from an app marketplace).

The computers may include a presentation interface to present data to a user, such as though a monitor and speakers. The presentation interface may facilitate receipt of requests for operation from users and/or presentation of information to users.

The user device may act as a client and may allow a user to access the TTV server and/or instructions stored on the TTV server. The client may be a computer system such as a personal computer, a laptop, a personal digital assistant, a smart phone, or any computer system appropriate for communicating with the controller. For example, a user may utilize a user device, such as a tablet computer, to access the libraries of the TTV server. As another example, a user may utilize a client, such as a smart phone, to generate the video messages based on a provided text message.

The TTV app may be based on any appropriate platform, such as Android operating system, iOS, and/or any other appropriate platform.

Although FIG. 1 provides one example of TTV server that may be used with the disclosure, TTV server can be implemented through computers such as servers, as well as a server pool. For example, TTV server may include a general-purpose personal computer (PC) a Macintosh, a workstation, a UNIX-based computer, a server computer, or any other suitable device. In some implementations, a TTV server may include a programmable logic device. According to one implementation, the controller may include a web server. The TTV server may be adapted to execute any operating system including UNIX, Linux, Windows, or any other suitable operating system. TTV server may include software and/or hardware, in any combination, suitable to provide access to data and/or translate data to an appropriate compatible format.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system, including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable signal(s) may be non-transitory waves and/or non-transitory signals.

There may be implementations where a user may add new video assignments to words that have already been assigned. Then, the user may use any of those video assignments when using that word in the future.

Although users have been described as a human, a user may be a person, a group of people, a person or persons interacting with one or more computers, and/or a computer system.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a user” includes a combination of two or more users and reference to “a video clip” includes different types and/or combinations of video clips.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method of generating a video message, comprising:
providing a text message to a receiver, wherein a first user provides the text message on at least one first user device;
retrieving media from the at least one first user device based on the text message;
generating the video message based on receiver information associated with the text message and the media retrieved from the at least one first user device; and
transmitting the video message to at least one second user device.

2. The method of claim 1, further comprising:
transmitting the text message to the at least one second user device.

3. The method of claim 1, further comprising:
generating the video message via a text-to-video (TTV) server, wherein the receiver information is stored in a memory on the TTV server.

4. The method of claim 1, further comprising:
generating the video message based on the receiver information retrieved from sources including an application marketplace and third-party advertisers.

5. The method of claim 1, further comprising:
generating the video message based on user preferences.

6. The method of claim 1, further comprising:
editing the video message on the at least one first user device.

7. The method of claim 1, wherein the text message includes alphanumeric characters, symbols, or any combination thereof.

8. The method of claim 1, wherein the media retrieved from the at least one first user device includes video, audio, and images.

9. The method of claim 1, wherein the at least one first user device and the at least one second user device each include at least one of a library, a cell phone, a tablet, an accessory, Wi-Fi, remote storage, and a satellite network.

10. The method of claim 1, further comprising:
replacing an element within the video message, wherein the element includes an item selected from the media including video, audio, and images.

11. A system having a non-transitory, computer readable medium, the system comprising:
a receiving unit configured to receive a text message, wherein at least one first user device provides the text message and retrieves media based on the text message; and
a text-to-video (TTV) module configured to generate the video message based on receiver information associated with the text message and the media retrieved from the at least one first user device,
the at least one first user device configured to transmit the video message to at least one second user device.

12. The system of claim 11, further comprising:
the at least one first user device configured to transmit the text message to the at least one second user device.

13. The system of claim 11, wherein the TTV module is configured to store the receiver information in a memory unit.

14. The system of claim 11, wherein the TTV module is configured to generate the video message based on the receiver information retrieved from sources including an application marketplace and third-party advertisers.

15. The system of claim 11, wherein the TTV module is configured to generate the video message based on user preferences.

16. The system of claim 11, wherein the TTV module is configured to edit the video message on the at least first user device.

17. The system of claim 11, wherein the text message includes alphanumeric characters, symbols, or any combination thereof.

18. The system of claim 11, wherein the media retrieved from the at least one first user device includes video, audio, and images.

19. The system of claim 11, wherein the at least one first user device and the at least one second user device each include at least one of a library, a cell phone, a tablet, an accessory, Wi-Fi, remote storage, and a satellite network.

20. The system of claim 11, wherein the at least one first user device is configured to replace an element within the video message, wherein the element includes an item selected from the media including video, audio, and images.
